(19) United States
(12) Patent Application Publication
(10) Pub. No.: US 2025/0221597 A1
(43) Pub. Date: Jul. 10, 2025

(54) ROBOT CLEANER AND CONTROLLING METHOD THEREOF

(71) Applicant: SAMSUNG ELECTRONICS CO., LTD., Suwon-si (KR)

(72) Inventors: Mideum CHOI, Suwon-si (KR); Youngil KOH, Suwon-si (KR); Jaeha LEE, Suwon-si (KR); Eunsoll CHANG, Suwon-si (KR)

(73) Assignee: SAMSUNG ELECTRONICS CO., LTD., Suwon-si (KR)

(21) Appl. No.: 19/054,251

(22) Filed: Feb. 14, 2025

Related U.S. Application Data
(63) Continuation of application No. PCT/KR2025/000517, filed on Jan. 9, 2025.

(30) Foreign Application Priority Data
Jan. 9, 2024 (KR) 10-2024-0003758

(51) Int. Cl. A47L 11/40; A47L 11/293

(52) U.S. Cl. CPC A47L 11/4011; A47L 11/293; A47L 11/4008; A47L 11/4061; A47L 2201/00

(57) ABSTRACT

A robot cleaner includes: at least one sensor; a wet brush; a driver; at least one memory storing at least one instruction; and at least one processor configured to execute the at least one instruction, where, by executing the at least one instruction, the at least one processor is configured to: obtain information about liquid on a floor through the at least one sensor in a state in which the robot cleaner performs a forward drive; determine a driving path for cleaning the liquid based on the information about the liquid; and control the driver to cause the robot cleaner to perform a backward drive along the driving path, and where the wet brush faces a direction opposite to a direction in which the robot cleaner proceeds in the state in which the forward drive is performed.

### CROSS-REFERENCE TO RELATED APPLICATION(S)

This application is a continuation application, claiming priority under § 365 (c), of an International application No. PCT/KR2025/000517, filed on Jan. 9, 2025, which is based on and claims the benefit of a Korean patent application number 10-2024-0003758, filed on Jan. 9, 2024, in the Korean Intellectual Property Office, the disclosure of which is incorporated by reference herein in its entirety.

### BACKGROUND

### 1. Field

The present disclosure relates to a robot cleaner and a controlling method thereof, and more particularly to, a robot cleaner capable of cleaning liquid on a floor and a controlling method thereof.

### 2. Description of Related Art

Technology for a robot cleaner capable of cleaning a floor while automatically moving along a driving path has been developed continuously, and recently, there is a need for technology to perform cleaning in an appropriate method by taking into account various types of floors and various types of objects present on the floor.

When there is liquid such as beverages, pet urine, etc. on the floor, an appropriate cleaning method that is different from when dry cleaning objects such as dust are present on the floor is needed in order for the robot cleaner to perform cleaning effectively.

For example, if the robot cleaner includes a wet brush (i.e., a wet mop), it may be more effective to perform cleaning using a wet brush for wet cleaning than to perform cleaning using a dry brush for dry cleaning.

However, in some examples, the wet brush of a robot cleaner may be disposed at the rear, in the opposite direction to the direction in which the robot cleaner is moving forward, and more specifically, behind the dry brush, suction port, and wheels of the robot cleaner. One reason for this configuration is because if the wet brush is disposed in the front, the moisture contained in the wet brush may interfere with the operation of the dry brush, suction port, and wheels.

Accordingly, if a wet brush is disposed at the rear of the robot cleaner, there may be a problem that when the robot cleaner is moving forward and cleaning liquid, the dry brush, suction port, wheels, etc. may be contaminated by the liquid before the liquid is cleaned through the wet brush, and this problem may lead to a failure of the robot cleaner.

### SUMMARY

### Technical Solution

Provided is a robot cleaner capable of cleaning liquid on a floor in an effective and efficient manner and a controlling method thereof.

Additional aspects will be set forth in part in the description which follows and, in part, will be apparent from the description, or may be learned by practice of the presented embodiments.

According to an aspect of the disclosure, a robot cleaner may include: at least one sensor; a wet brush; a driver; at least one memory storing at least one instruction; and at least one processor configured to execute the at least one instruction, where, by executing the at least one instruction, the at least one processor is configured to: obtain information about liquid on a floor through the at least one sensor in a state in which the robot cleaner performs a forward drive; determine a driving path for cleaning the liquid based on the information about the liquid; and control the driver to cause the robot cleaner to perform a backward drive along the driving path, and where the wet brush faces a direction opposite to a direction in which the robot cleaner proceeds in the state in which the forward drive is performed, and faces a direction in which the robot cleaner proceeds in a state in which the backward drive is performed.

The at least one processor may be further configured to: store information about the driving path in the at least one memory; and control the driver to perform the backward drive based on the information about the driving path stored in the at least one memory.

The information about the liquid may include at least one of information about a location of an area of the liquid, information about a size of the area of the liquid, information about a shape of the area of the liquid, or information about an amount of the liquid.

The robot cleaner as claimed in claim 3, where the at least one processor is further configured to determine the driving path to pass through at least a portion of the area of the liquid based on the information about the location of the area of the liquid.

The at least one processor may be further configured to: identify a size of the area based on the information about the size of the area of the liquid; based on the size of the area being less than a threshold size, determine the driving path to pass through a center point of the area; and based on the size of the area exceeding the threshold size, identify a polygon corresponding to the area based on the information about the shape of the area of the liquid, and determine the driving path to pass through a vertex that is closest to the robot cleaner among a plurality of vertices included in the polygon.

The at least one processor may be further configured to: detect an outline of the area based on the information about the shape of the area of the liquid; and identify the polygon corresponding to the area by performing simplification on the detected outline.

The at least one processor may be further configured to: identify a horizontal length of the area and a vertical length of the area based on the information about the shape of the area of the liquid; and based on the horizontal length and the vertical length being less than a preset threshold length, determine the driving to pass through the center point of the area.

The at least one processor may be further configured to, based on a first length among the horizontal length and the vertical length exceeding the preset threshold length and a second length among the horizontal length and the vertical length being less than the preset threshold length, determine the driving path to pass through a line segment corresponding to the first length.

The at least one processor may be further configured to: based on the horizontal length and the vertical length exceeding the preset threshold length, determine the driving path to pass through an end point that is closest to the robot cleaner among two end points of the line segment corresponding to the first length; and based on the robot cleaner passing through the end point, obtain second information about the liquid through the at least one sensor.

The at least one processor may be further configured to: determine whether to replace the wet brush based on the information about the amount of the liquid in the state in which the robot cleaner performs the backward drive along the driving path; based on determining that the wet brush is to be replaced, control the driver to cause the robot cleaner to move to a preset location; and based on the wet brush being replaced, control the driver to cause the robot cleaner to perform the backward drive along the driving path.

The robot cleaner may further include: a communicator, where the at least one processor is further configured to control the communicator to transmit to an external device at least some of the information about the liquid, information about the driving path, and information indicating whether the wet brush is to be replaced.

According to an aspect of the disclosure, provided is a controlling method of a robot cleaner including a wet brush, the method may include: obtaining information about liquid on a floor through at least one sensor in a state in which the robot cleaner performs a forward drive; determining a driving path for cleaning the liquid based on the information about the liquid; and controlling the robot cleaner to perform a backward drive along the driving path, where the wet brush faces a direction opposite to a direction in which the robot cleaner proceeds in the state in which the forward drive is performed, and faces a direction in which the robot cleaner proceeds in a state in which the backward drive is performed.

The method may further include: storing information about the driving path, where the controlling the robot cleaner includes controlling the robot cleaner to perform the backward drive based on the stored information about the driving path.

The information about the liquid may include at least one of information about a location of an area of the liquid, information about a size the area of the liquid, information about a shape of the area of the liquid, and information about an amount of the liquid.

The determining the driving path may include determining the driving path to pass through at least a portion of the area of the liquid based on the information about the location of the area of the liquid.

According to an aspect of the disclosure, a robot cleaner may include: at least one sensor on a first side of the robot cleaner corresponding to a front direction; a wet brush on a second side of the robot cleaner corresponding to a backward direction; a driver; at least one memory storing at least one instruction; and at least one processor configured to execute the at least one instruction, where, by executing the at least one instruction, the at least one processor is configured to: obtain information about liquid on a floor through the at least one sensor; determine a driving path for cleaning the liquid based on the information about the liquid; and control the driver to cause the robot cleaner to perform a backward drive along the driving path, and where the wet brush faces the backward direction in a state in which the backward drive is performed.

The information about the liquid may include information about a location of an area of the liquid, where the at least one processor may be further configured to determine the driving path to pass through at least a portion of the area of the liquid based on the information about the location of the area of the liquid.

The information about the liquid may include information about a size of an area of the liquid, and where the at least one processor may be further configured to: based on the size of the area being less than a threshold size, determine the driving path to pass through a center point of the area; and based on the size of the area exceeding the threshold size, identify a polygon corresponding to the area based on a shape of the area of the liquid, and determine the driving path to pass through a vertex that is closest to the robot cleaner among a plurality of vertices included in the polygon.

The at least one processor may be further configured to: identify a horizontal length of the area and a vertical length of the area based on the shape of the area of the liquid; and based on the horizontal length and the vertical length being less than a preset threshold length, determine the driving to pass through a center point of the area.

The at least one processor may be further configured to: based on a first length among the horizontal length and the vertical length exceeding the preset threshold length and a second length among the horizontal length and the vertical length being less than the preset threshold length, determine the driving path to pass through a line segment corresponding to the first length; based on the horizontal length and the vertical length exceeding the preset threshold length, determine the driving path to pass through an end point that is closest to the robot cleaner among two end points of the line segment corresponding to the first length; based on the robot cleaner passing through the end point, obtain second information about the liquid through the at least one sensor; and determine a second driving path for cleaning the liquid based on the second information about the liquid.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating a configuration of a robot cleaner according to one or more embodiments;

FIG. 2 is a view provided to explain an operation of a robot cleaner according to one or more embodiments;

FIG. 3 is a view provided to explain a method of obtaining information about liquid according to one or more embodiments;

FIG. 4 is a flowchart provided to explain a method related to determining a driving path of a robot cleaner based on information about a size of liquid according to one or more embodiments;

FIG. 5 and FIG. 6 are views provided to explain a driving path of a robot cleaner determined based on information about a size of liquid according to one or more embodiments;

FIG. 7 is a flowchart provided to explain a method related to determining a driving path of a robot cleaner based on information about a shape of liquid according to one or more embodiments;

FIG. 8, FIG. 9, FIG. 10, and FIG. 11 are views provided to explain a driving path of a robot cleaner determined based on information about a shape of liquid according to one or more embodiments;

FIG. 12 is a flowchart provided to explain a method related to replacing a wet brush while performing a backward drive according to one or more embodiments;

FIG. 13 is a view illustrating configuration of a robot cleaner in detail according to one or more embodiments; and

FIG. 14 is a flowchart illustrating a controlling method of a robot cleaner according to one or more embodiments.

### DETAILED DESCRIPTION

The embodiments of the present disclosure may be variously modified and have several exemplary embodiments, and some exemplary embodiments of the disclosure will be illustrated in the drawings and be described in detail in the detailed description. However, it is to be understood that the disclosure is not limited to specific exemplary embodiments, but include all modifications, equivalents, and/or alternatives according to exemplary embodiments of the disclosure. Throughout the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following exemplary embodiments may be modified in several different forms, and the scope and spirit of the disclosure are not limited to the following exemplary embodiments. Rather, these exemplary embodiments make the disclosure thorough and complete, and are provided to completely transfer the spirit of the disclosure to those skilled in the art.

Terms used in the disclosure are used only to describe specific exemplary embodiments rather than limiting the scope of the disclosure. Singular forms are intended to include plural forms unless the context clearly indicates otherwise.

In the disclosure, the expressions “have”, “may have”, “include”, “may include”, “comprise”, “may comprise”, and variations thereof used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory apparatus.

In exemplary embodiments, a “module” or a “unit” may perform at least one function or operation, and be implemented by hardware or software or be implemented by a combination of hardware and software. In addition, a plurality of “modules” or a plurality of “units” may be integrated into at least one module and be implemented by at least one processor except for a ‘module’ or a ‘unit’ that needs to be implemented by specific hardware.

Meanwhile, various elements and regions in the drawings are schematically drawn. Therefore, the technical concept of the disclosure is not limited by a relative size or spacing drawn in the accompanying drawings.

Hereinafter, embodiments of the present disclosure will be described in detail with reference to the accompanying drawings, so that those skilled in the art can easily implement them.

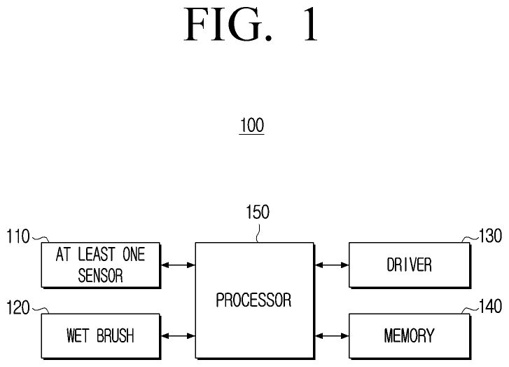

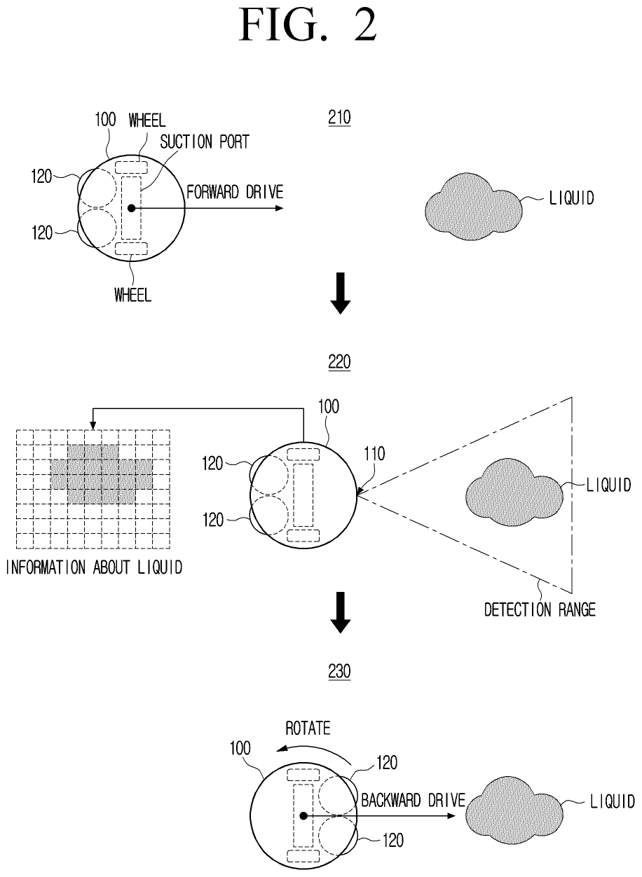

FIG. 1 is a view illustrating a configuration of a robot cleaner 100 according to one or more embodiments. FIG. 2 is a view provided to explain an operation of the robot cleaner 100 according to one or more embodiments. Hereinafter, the robot cleaner 100 will be described with reference to FIGS. 1 and 2 together.

As shown in FIG. 1, the robot cleaner 100 may include at least one sensor 110, a wet brush 120, a driver 130, memory 140, and a processor 150.

The at least one sensor 110 may detect various information inside and outside of the robot cleaner 100. The at least one sensor 110 may include an image sensor and an object detection sensor, and may detect various information about objects disposed outside the robot cleaner 100, that is, in the cleaning space.

The term ‘image sensor’ is used to collectively refer to a sensor that detects light and converts it into an image. In other words, in this disclosure, the term ‘image sensor’ is used to include a camera including an image sensor and a vision sensor performing image processing based on the image sensor.

The term ‘object detection sensor’ is used to collectively refer to a sensor capable of recognizing the presence and feature of objects disposed in the surrounding environment of the robot cleaner 100. The object detection sensor may include various types of sensors capable of obtaining information about an object by emitting light and receiving light reflected by the object. For example, the object detection sensor may include a LiDAR (Light Detection And Ranging) sensor, a time of flight (ToF) sensor, an ultrasonic sensor, an infrared sensor, and the like. The object detection sensor may obtain various information such as the distance between the robot cleaner 100 and an object, the size of the object, the shape of the object, the color of the object, and the like.

The processor 150 may obtain information about liquid present on a floor via the at least one sensor 110. In other words, in an embodiment of the present disclosure, an object detected through the at least one sensor 110 may be liquid present on the floor among other foreign substances to be cleaned.

In one or more embodiments, the processor 150 may obtain an image of a floor where liquid is present via an image sensor. Subsequently, by analyzing the image of the floor, the processor 150 may obtain information about liquid present on the floor. Based on the size, shape, color, and the like of an object included in the image of the floor, the processor 150 may identify that liquid is present on the floor, and may obtain information about the location, size, and shape of the area where liquid is distributed on the floor, and may also obtain information about the amount of liquid.

In one or more embodiments, the processor 150 may obtain information about liquid present on the floor via an object detection sensor. The object detection sensor may detect the liquid as an object to be detected. In other words, the object detection sensor may obtain various information such as the distance between the liquid present on the floor and the robot cleaner 100, the size, shape, color, reflectivity, etc. of the liquid, and the like.

The processor 150 may obtain information about the liquid by inputting the image of the floor into a trained neural network model. For example, the processor 150 may input an image of the floor to a neural network model trained to identify types of objects included in the input image to identify that liquid is present on the floor. In addition, the processor 150 may obtain information about the liquid by inputting the image of the floor to a neural network model trained to output information about the liquid included in the input image. The criteria (i.e., domain or class) by which the neural network model classifies the input image, the type of neural network, and the like may be determined in various ways depending on embodiments.

In the present disclosure, the term ‘liquid present on the floor’ is used to collectively refer to any foreign substances including liquid properties among foreign substances present on the floor, which is the cleaning space of the robot cleaner 100. Specifically, the liquid present on the floor may be a foreign substance that cannot be sucked in through the suction port of the robot cleaner 100, or may contaminate a suction port and a plurality of wheels or cause a failure thereof if suction is attempted.

The ‘state of matter’ present on the floor does not necessarily require that it be liquid, and a foreign substance that is currently on the floor in the solid form but was liquid at the time when it fell to the floor may be considered liquid to be cleaned according to the present disclosure. Conversely, a foreign substance that is currently on the floor in the liquid form but was solid at the time when it fell to the floor may also be considered liquid to be cleaned according to an embodiment of the present disclosure. For example, liquid on the floor may include many various types of foreign substances such as water, stains caused by drinks left for a certain period of time, traces of melted ice cream, etc.

In the present disclosure, the term “information about liquid” is used to collectively refer to information about liquid present on a floor. The information about the liquid may include at least one of information about a location of the area where the liquid is distributed on the floor, information about a size of the area where the liquid is distributed on the floor, information about a shape of the area where the liquid is distributed on the floor, and information about an amount of the liquid.

The various ways in which the processor 150 obtains information about the liquid via the at least one sensor 110 will be described more specifically in the description of the processor 150.

The “wet brush 120” refers to a brush capable of performing wet cleaning on the floor in a wet state, and may be referred to by terms such as “mop” or “wet mop” or the like. In other words, any brush that can be used to perform wet cleaning among various types of brushes that can be included in the robot cleaner 100 may correspond to the wet brush 120 according to the present disclosure.

For example, the wet brush 120 may receive water from a user or a water tank, desorb contaminants adsorbed on the floor in the wet state, and sweep the desorbed contaminants away such that the suction port of the robot cleaner 100 can easily collect the desorbed contaminants. The operation of performing cleaning using the wet brush 120 may be simply referred to as ‘wet cleaning’, and the operation for cleaning liquid using the wet brush 120 may be referred to as ‘liquid cleaning mode.’

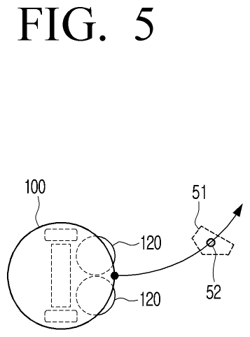

FIG. 2 illustrates the robot cleaner 100 viewed from above according to an embodiment of the present disclosure, and the arrow in FIG. 2 represents a portion of the driving path of the robot cleaner 100. FIGS. 5, 6, and 8 to 11 illustrate the appearance of the robot vacuum cleaner 100 and a portion of the driving path in the same manner as in FIG. 2.

As shown in FIG. 2, the wet brush 120 may be circular in shape, and the number of wet brushes 120 may be two. The wet brush 120 may be implemented to rotate about an axis perpendicular to the floor while wet cleaning is performed on the floor. However, there is no particular limitation on the shape, number, and function of the wet brush 120 according to the present disclosure.

The wet brush 120 may be distinguished from a dry brush 160, which is configured to perform dry cleaning, and the term ‘dry brush 160’ refers to a brush that is capable of cleaning the floor without being wet with water. For example, dry brush 160 may sweep up contaminants, such as dirt, disposed on the floor, allowing the suction port of the robot cleaner 100 to easily collect the contaminants. The operation of performing cleaning using the dry brush 160 may be referred to simply as ‘dry cleaning,’ and the operation of performing cleaning using the dry brush 160 may be referred to as ‘general cleaning mode,’ as distinguished from ‘liquid cleaning mode.’

If the robot cleaner 100 includes both the dry brush 160 and the wet brush 120, and is implemented to control the location of the wet brush 120, the robot cleaner 100 may perform cleaning without using the wet brush 120 when operating in a dry mode, and may perform water cleaning using the wet brush 120 by automatically controlling the location of the wet brush 120 when operating in a wet mode.

According to one or more embodiments, the wet brush 120 may face a direction opposite to the travel direction of the robot cleaner 100 while a forward drive of the robot cleaner 100 is performed, and may face the travel direction of the robot cleaner 100 while a backward drive of the robot cleaner 100 is performed.

Here, the ‘forward drive’ means that the robot cleaner 100 travels such that the front of the robot cleaner 100 faces a destination, and ‘backward drive’ means that the robot cleaner 100 travels such that the rear of the robot cleaner 100 faces a destination. Here, the destination collectively refers to an intermediate destination or a final destination on the driving path. In addition, in the present disclosure, the direction in which the wet brush 120 is disposed is defined as the ‘rear’ of the robot cleaner 100, and the direction opposite to the direction in which the wet brush 120 is disposed is defined as the ‘front’ of the robot cleaner 100. The words ‘front’ and ‘rear’ can be replaced by terms such as ‘front side’, ‘rear side’ and ‘front area.’

As described above, the forward drive refers to driving with the front of the robot cleaner 100 facing a destination, so while performing the forward drive, the wet brush 120 disposed at the rear of the robot cleaner 100 faces a direction opposite to the direction in which the robot cleaner 100 proceeds. In addition, as described above, the backward drive refers to driving with the rear of the robot cleaner 100 faces a destination, so while performing the backward drive, the wet brush 120 disposed at the rear of the faces the direction in which the robot cleaner 100 proceeds.

Referring to FIG. 2, a suction port, a plurality of wheels, and the wet brush 120 may be disposed on the lower surface of the robot cleaner 100. In addition, the wet brush 120 may be disposed behind the suction port. As shown in an image 210 of FIG. 2, while the robot cleaner 100 moves forward, the wet brush 120 may face backward, which is a direction opposite to the direction in which the robot cleaner 100 proceeds. On the other hand, as shown in an image 230 of FIG. 2, while the robot cleaner 100 moves backward, the wet brush 120 may face forward, which is the direction in which the robot cleaner 100 proceeds.

The driver 130 may control the drive of the robot cleaner 100. The driver 130 may include a plurality of wheels and at least one motor, and the at least one motor may include a suction motor, a brush control motor, a wheel motor, and the like. The at least one motor included in the driver 130 may be implemented as various types of motors, including a direct current (DC) motor, an alternative current (AC) motor, a brushless DC (BLDC) motor, and the like.

The ‘suction motor’ refers to a motor capable of generating suction pressure. When a control signal is received from the processor 150 and power is supplied from a power source, an impeller may be rotated by driving the suction motor. The rotation of the impeller creates suction pressure, which may cause air including contaminants to be sucked into the suction port of the robot cleaner 100. As the speed of the suction motor increases, the suction pressure may increase.

The ‘brush motor’ refers to a motor capable of controlling the location and motion of at least one of a plurality of brushes included in the robot cleaner 100. For example, the processor 150 may control the brush motor to cause the wet brush 120 to rotate about an axis perpendicular to the floor while performing wet cleaning of the floor using the wet brush 120.

Further, the processor 150 may control the brush motor to lower the position of the wet brush 120 in order to perform cleaning of the floor using the wet brush 120. Additionally, the processor 150 may control the brush motor to raise the position of the wet brush 120 in order to not perform cleaning of the floor using the wet brush 120.

The ‘wheel motor’ may control the operation of a wheel included in the robot cleaner 100. The wheel motor may control the rotation direction and speed of a wheel included in the robot cleaner 100, thereby controlling the direction and speed of movement of the robot cleaner 100. When the robot cleaner 100 includes two wheels, a left wheel and a right wheel, the wheel motor may include a left wheel motor and a right wheel motor, and the left wheel motor and the right wheel motor may control the rotation direction and speed of the left wheel and the right wheel, respectively.

The memory 140 may store at least one instruction regarding the robot cleaner 100. In addition, the memory 140 may store an operating system (O/S) for operating the robot cleaner 100. The memory 140 may also store various software programs or applications for operating the robot cleaner 100 according to various embodiments of the present disclosure. The memory 140 may include a semiconductor memory such as a flash memory, or magnetic storage media such as a hard disk, or the like.

The memory 140 may store various software modules for operating the robot cleaner 100 according to various embodiments of the present disclosure, and the processor 150 may control the operation of the robot cleaner 100 by executing various software modules stored in the memory 140. In other words, the memory 140 may be accessed by the processor 150, and the data may be read/written/modified/deleted/updated, etc. by the processor 150.

The term ‘memory 140’ in this disclosure may be used to include the memory 140, ROM or RAM in the processor 150, or a memory card (e.g., micro SD card, memory stick) mounted in the robot cleaner 100.

In one or more embodiments, the memory 140 may store information about liquid present on the floor, information about a driving path of the robot cleaner 100, data about a neural network model, and the like. In addition, various information for achieving an object of the present disclosure may be stored in the memory 140, and the information stored in the memory 140 may be updated as it is received from an external device or input by the user.

The processor 150 may control the overall operations of the robot cleaner 100. For example, the processor 150 may be connected to a configuration of the robot cleaner 100 that includes the at least one sensor 110, the driver 130, and the memory 140, and may control the overall operations of the robot cleaner 100 by executing at least one instruction stored in the memory 140, as described above.

The processor 150 may be implemented in various ways. For example, the processor 150 may be implemented as one or more processors, such as at least one of Application Specific Integrated Circuit (ASIC), embedded processor, microprocessor, hardware control logic, hardware Finite State Machine (FSM), or Digital Signal Processor (DSP). The term ‘processor 150’ in this disclosure may be used to include a Central Processing Unit (CPU), a Graphic Processing Unit (GPU), a Micro Processor Unit (MPU), and the like.

In one or more embodiments, the processor 150 may obtain information about liquid present on the floor while performing a forward drive, and perform cleaning of the liquid present on the floor by performing a backward drive. Various embodiments implemented by the control of the processor 150 will be described below with reference to FIG. 2.

The processor 150 may obtain information about liquid present on the floor via the at least one sensor 110 while the robot cleaner 100 is performing a forward drive. For example, the processor 150 may control the driver 130 to cause the robot cleaner 100 to perform a forward drive. The processor 150 may control the driver 130 to perform wet cleaning using the wet brush 120, and the processor 150 may control the driver 130 to perform dry cleaning using the dry brush 160. In addition, the processor 150 may obtain information about liquid that is within a detection range of the at least one sensor 110 via the at least one sensor 110 while the robot cleaner 100 is performing a forward drive.

The image 210 of FIG. 2 illustrates the operation of the robot cleaner 100 performing a forward drive. As shown in the image 210, while the robot cleaner 100 performs a forward drive, the wet brush 120 may face a direction that is opposite to the direction in which the robot cleaner 100 proceeds.

The image 220 of FIG. 2 illustrates the process of obtaining information about liquid via the at least one sensor 110 while the robot cleaner 100 is performing a forward drive. As shown in the image 220, the at least one sensor 110 may obtain information about objects within a detection range in front of the robot cleaner 100, and may obtain information about liquid present within the detection range. However, the detection range by the at least one sensor 110 is not necessarily limited to the front area of the robot cleaner 100.

Based on the information about the liquid, the processor 150 may determine a driving path for cleaning the liquid. For example, the processor 150 may determine the driving path based on at least one of information about a location of an area where the liquid is distributed on the floor, information about a size of the area where the liquid is distributed on the floor, information about a shape of the area where the liquid is distributed on the floor, and information about an amount of the liquid.

In one or more embodiments, the processor 150 may determine a driving path such that the robot cleaner 100 passes through at least a portion of the area where liquid is distributed based on information about a location of the area where the liquid is distributed. In other words, the processor 150 may determine a driving path such that the robot cleaner 100 passes through the area where the liquid is distributed, rather than avoiding the area where the liquid is distributed.

For example, the processor 150 may store information about the liquid in the form of a grid map as shown in the image 220 of FIG. 2. The grid map in the image 220 may include a plurality of grids corresponding to each location in the cleaning space, and may indicate whether an object is present at the location corresponding to each of the plurality of grids, the type of the object, and the like. When information about the liquid is obtained, such as in the grid map of image 220, the processor 150 may determine a driving path such that the robot cleaner 100 passes through at least one of the plurality of grids corresponding to the location of the liquid.

Which point to pass through at each location in the area where the liquid is distributed may be determined based on information about the size of the area where the liquid is distributed on the floor, information about the shape of the area where the liquid is distributed on the floor, etc.

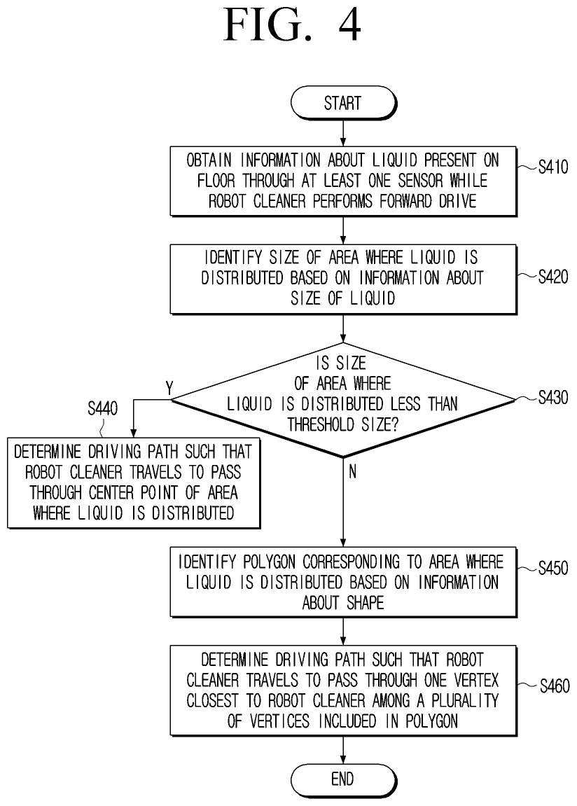

In one or more embodiments, the processor 150 may identify whether the size of the area where the liquid is distributed is less than a threshold size based on the information about the size of the area where the liquid is distributed. When it is identified that the size of the area where the liquid is distributed is less than the threshold size, the processor 150 may determine a driving path such that the robot cleaner 100 passes through the center point of the area where the liquid is distributed. According to an embodiment, when the size of the area where the liquid is distributed exceeds the threshold size, the processor 150 may determine a driving path based on information about the shape where the liquid is distributed. An embodiment related to this will be described in greater detail with reference to FIGS. 4 to 6.

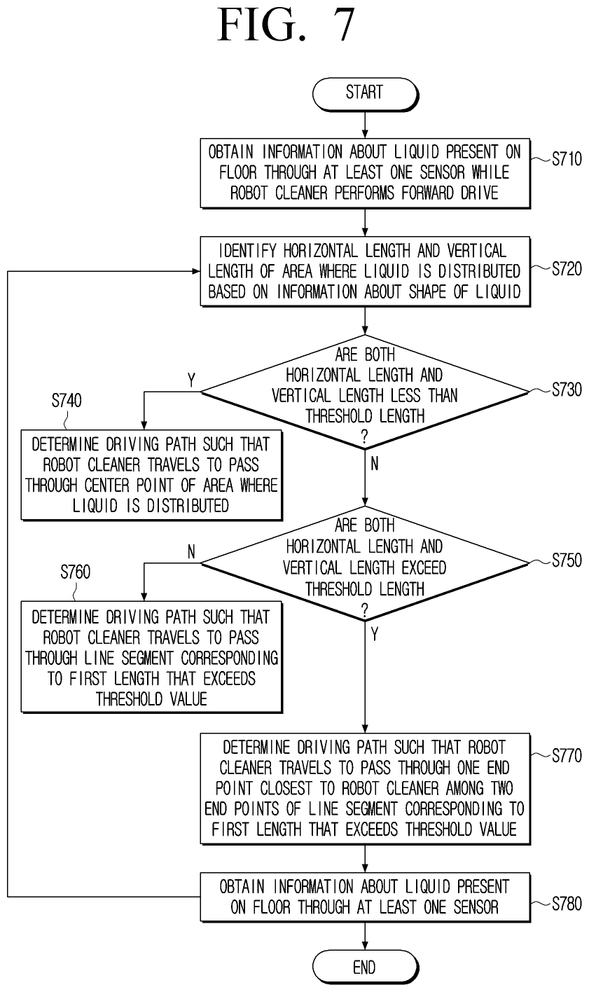

In one or more embodiments, the processor 150 may identify a horizontal length and a vertical length of the area where the liquid is distributed based on information about the shape of the area where the liquid is distributed. Subsequently, the processor 150 may identify whether the horizontal length and the vertical length of the area where the liquid is distributed is less than a preset threshold length. When it is identified that the horizontal length and the vertical length are less than the threshold length, the processor 150 may determine a driving path such that the robot cleaner 100 passes through the center point of the area where the liquid is distributed. According to an embodiment, when at least one of the horizontal length and the vertical length is greater than the threshold length, the processor 150 may determine a driving path based on the shape where the liquid is distributed. One or more embodiments related to this will be described in greater detail with reference to FIGS. 7 to 11.

The processor 150 may control the driver 130 to cause the robot cleaner 100 to perform a backward drive in accordance with the driving path. In other words, when a driving path for cleaning the liquid is determined based on information about the liquid, the robot cleaner 100 may perform a backward drive in accordance with the determined driving path. Thus, in the present disclosure, the term “driving path” may refer to a backward driving path of the robot cleaner 100.

As described above, the processor 150 may determine a driving path such that the robot cleaner 100 passes through at least a portion of the area where the liquid is distributed. However, in this case, when the robot cleaner 100 performs a forward drive, the liquid may cause contamination, degradation, or failure of a plurality of wheels, the dry brush 160, and the like.

As described above, a backward drive refers to driving with the rear of the robot cleaner 100 facing a destination, such that the wet brush 120 disposed at the rear of the robot cleaner 100 faces the direction in which the robot cleaner proceeds while a backward drive is performed. In this case, in order to reduce the likelihood of contamination, degradation, or failure of a plurality of wheels, the dry brush 160, etc. by the liquid, the processor 150 may control the driver 130 to perform the backward drive when the robot cleaner 100 passes through at least a portion of the area where the liquid is distributed.

In order to perform a backward drive, the processor 150 may control the driver 130 such that the wet brush 120 faces the direction in which the robot cleaner 100 proceeds, of travel of the robot cleaner 100 and accordingly, the robot cleaner 100 may be rotated such that the wet brush 120 faces the direction in which the robot cleaner 100 proceeds. Once the robot cleaner 100 is rotated such that the wet brush 120 faces the direction in which the robot cleaner 100 proceeds, the processor 150 may control the driver 130 to cause the robot cleaner 100 to perform a backward drive along a driving path determined based on the information about the liquid.

The image 230 of FIG. 2 illustrates the robot cleaner 100 performing a backward drive. As shown in FIG. 2, the robot cleaner 100 may be rotated such that the wet brush 120 faces the direction in which the robot cleaner 100 proceeds in order to perform a backward drive. While FIG. 2 is based on the assumption that the rotation angle of the robot cleaner 100 for a backward travel is 180 degrees, the angle at which the robot cleaner 100 rotates for a backward drive may vary depending on the current location of the robot cleaner 100 and the location of the robot cleaner 100 on the driving path for performing a backward drive.

When the robot cleaner 100 is rotated such that the wet brush 120 faces the direction in which the robot cleaner 100 proceeds, the detection range that the at least one sensor 110 can detect may be limited to the opposite direction of the direction in which the robot cleaner 100 moves backward. In other words, while the robot cleaner 100 is performing a backward drive, the processor 150 may not be able to detect any additional information about the liquid via the at least one sensor 110. Accordingly, the processor 150 may store information about the driving path in the memory 140, and may control the driver 130 to perform a backward drive based on the information about the driving path stored in the memory 140.

According to an embodiment, the detection range of the at least one sensor 110 may be implemented to cover the direction in which the robot cleaner 100 moves backward and in this case, the processor 150 may obtain information about the liquid via the at least one sensor 110 even while the robot cleaner 100 is performing a backward drive.

According to one or more embodiments described above with reference to FIGS. 1 and 2, when liquid present on the floor is detected while the robot cleaner 100 performs a forward drive, cleaning of the liquid may be performed in a backward drive where the wet brush 120 faces the direction in which the robot cleaner 100 proceeds, thereby effectively and efficiently cleaning the liquid on the floor.

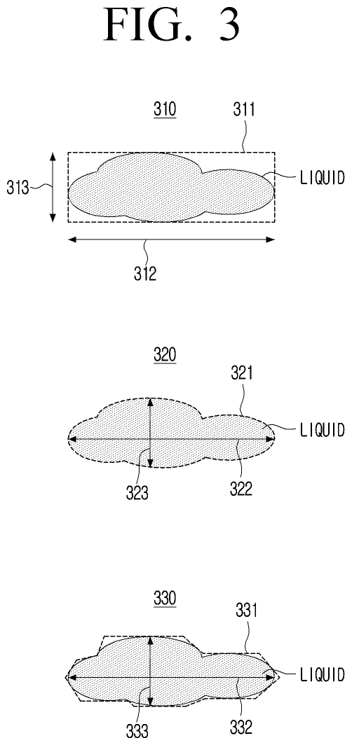

FIG. 3 is a view provided to explain one or more embodiments related to a method of obtaining information about liquid.

As described above, the processor 150 may obtain information about liquid present on the floor via the at least one sensor 110 while the robot cleaner 100 is performing a forward drive. For example, the processor 150 may obtain information about liquid present on the floor by obtaining an image of the floor via an image sensor and analyzing the image of the floor. In addition, the processor 150 may obtain information about liquid present on the floor via an object detection sensor.

The information about liquid may include not only information obtained via the at least one sensor 110 but also information obtained based on the information obtained via the at least one sensor 110. For example, the information about liquid may include at least one of information about a location of the area where the liquid is distributed on the floor, information about a size of the area where the liquid is distributed on the floor, information about a shape of the area where the liquid is distributed on the floor, and information about an amount of the liquid. Hereinafter, one or more embodiments of obtaining information about various types of liquid based on information obtained via the at least one sensor 110 will be described.

In one or more embodiments, the processor 150 may obtain information about a location of the area where the liquid is distributed. As shown in an image 310 of FIG. 3, the processor 150 may obtain information about the location of the area where the liquid is distributed by identifying a rectangle 311 corresponding to the location of the area where the liquid is distributed.

In one or more embodiments, the processor 150 may detect an outline of the area where the liquid is distributed. As shown in an image 320 of FIG. 3, the processor 150 may detect an outline 321 of the area where the liquid is distributed using various types of outline detection methods. For example, the outline detection methods may include various techniques such as Canny-Edge Detector, Sobel operator, Laplacian of Gaussian (LoG), Roberts Cross Operator, and the like.

Here, the Canny-Edge Detector may include applying a Gaussian filter to remove noise from an image, calculating the gradient of each pixel in the image to identify the point in the image where the change is greatest, inspecting the image based on the direction of the gradient to only leave outlines in the direction where the gradient is greatest at each pixel and remove the rest, distinguishing between strong and weak outlines using two threshold values, and finally tracing the weak edges connected to the strong outlines to create a complete outline map.

In one or more embodiments, the processor 150 may perform simplification on the detected outline to identify a polygon corresponding to the area where liquid is distributed. As shown in an image 330 of FIG. 3, the processor 150 may perform simplification on the detected outline 321 to identify a polygon 331 corresponding to the area where the liquid is distributed, as shown in the image 320 of FIG. 3. For example, the simplification technique for the outline may include various techniques such as Ramer-Douglas-Peucker, Douglas-Peucker Algorithm, Visvalingam's Algorithm, and the like.

Here, the Ramer-Douglas-Peucker may include selecting a start point and an end point from a given outline (a set of points), finding the farthest point among all points between the start point and the end point, dividing the outline into two subsets by a line segment including the farthest point when the distance from the farthest point is greater than a given threshold value (precision), recursively repeating the above process for the divided two subsets, and repeating until all subsets fall within the given precision.

The processor 150 may identify a horizontal length and a vertical length of the area where the liquid is distributed based on the information about the shape. Here, a first length among the horizontal length and the vertical length may be a distance between points having the longest distance among the points included in the area where the liquid is distributed, and a second length among the horizontal length and the vertical length may be a distance between points perpendicular to the first length and having the longest distance among the points included in the area where the liquid is distributed.

For example, when the rectangle 311 representing the area where the liquid is distributed is detected, the horizontal length and the vertical length may be a horizontal length 312 and a vertical length 313 of the image 310 in FIG. 3. When the outline 321 representing the area where the liquid is distributed is detected, the horizontal length and the vertical length may be a horizontal length 322 and a vertical length 323 of the image 320 in FIG. 3. When the polygon 331 representing the area where the liquid is distributed is detected, the horizontal length and the vertical length may be a horizontal length 332 and a vertical length 333 of the image 330 in FIG. 3. In addition, the horizontal length and the vertical length of the area where the liquid is distributed may be determined based on various criteria.

In the above, the processes of identifying a rectangle, an outline, and a polygon corresponding to the location of the area where the liquid is distributed have been described in turn, and these processes may be performed sequentially in the order described above or may be performed independently.

One or more embodiments of obtaining information about liquid have been described above, and hereinafter, one or more embodiments related to determining a driving path of the robot cleaner 100 based on information about liquid will be described with reference to FIGS. 4 to 11.

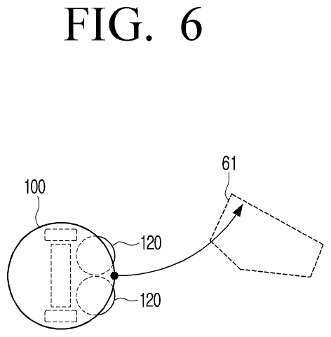

FIG. 4 is a flowchart provided to explain one or more embodiments related to determining a driving path of the robot cleaner 100 based on information about a size of liquid, and FIGS. 5 and 6 are views provided to explain a driving path of the robot cleaner 100 determined based on information about a size of liquid.

As described above, the processor 150 may obtain information about liquid present on the floor via the at least one sensor 110 while the robot cleaner 100 is performing a forward drive (S410).

The processor 150 may identify the size of the area where the liquid is distributed based on information about the size of the liquid (S420). For example, as described above with reference to FIG. 3, when a rectangle, an outline, a polygon, or the like representing the area where the liquid is distributed is detected, the processor 150 may identify the size of the area where the liquid is distributed by calculating the size of the rectangle, outline, polygon, or the like representing the area where the liquid is distributed.

When the size of the area where the liquid is distributed is less than a threshold size (S430—Y), the processor 150 may determine a driving path such that the robot cleaner 100 travels to pass through the center point of the area where the liquid is distributed (S440). Here, the ‘threshold size’ may be determined based on the size of the wet brush 120. For example, the threshold size may be determined to be the same size as the size of the wet brush 120, or the threshold size may be determined based on various other criteria. Further, the threshold size may be changed according to the settings of the user or developer.

For example, when the threshold size is determined to be the same size as the size of the wet brush 120, if the size of the area where the liquid is distributed is less than the size of the wet brush 120, it is likely that the wet brush 120 will complete cleaning of the area where the liquid is distributed by passing through the area where the liquid is distributed only once. Accordingly, the processor 150 may determine a driving path such that the robot cleaner 100 travels to pass through a center point 52 of an area 51 where the liquid is distributed, as shown by the arrow in FIG. 5. Here, the ‘center point of the area where the liquid is distributed’ may be the center of gravity of a shape representing the area where the liquid is distributed, and the center point may be determined based on various other criteria. The traveling method where the wet brush 120 passes through the center point of the area where the liquid is distributed, as shown in FIG. 5, may be simply referred to as a center point-directed drive.

According to an embodiment, when the size of the area where the liquid is distributed exceeds a threshold size (S430—N), the processor 150 may identify a polygon corresponding to the area where the liquid is distributed based on information about the shape (S450), and determine a driving path such that the robot cleaner 100 travels to pass through one vertex closest to the robot cleaner 100 among a plurality of vertices included in the polygon (S460).

For example, when the threshold size is determined to be the same size as the size of the wet brush 120, if the size of the area where the liquid is distributed exceeds the size of the wet brush 120, it is unlikely that the wet brush 120 can complete cleaning of the area where the liquid is distributed by passing through the area where the liquid is distributed only once. Accordingly, the processor 150 may determine a driving path such that the robot cleaner 100 travels to pass through one vertex closest to the robot cleaner 100 among a plurality of vertices included in a polygon 61, as shown by the arrow in FIG. 6.

When the size of the area where the liquid is distributed exceeds a threshold size, if the robot cleaner 100 travels to pass through the center point of the area where the liquid is distributed, the liquid remains on both sides of the area where the robot cleaner 100 has passed, so it may be difficult to clean the remaining liquid efficiently. On the other hand, if the robot cleaner 100 travels to pass through one vertex included in the polygon corresponding to the area where the liquid is distributed, the liquid remains on one side of the area where the robot cleaner 100 has passed, so it is possible to clean the remaining liquid efficiently.

The operation of the robot cleaner 100 after the robot cleaner 100 passes through one vertex closest to the robot cleaner 100 among a plurality of vertices included in the polygon will be described below with reference to FIGS. 9 and 10.

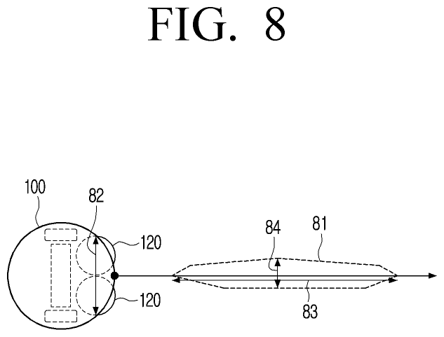

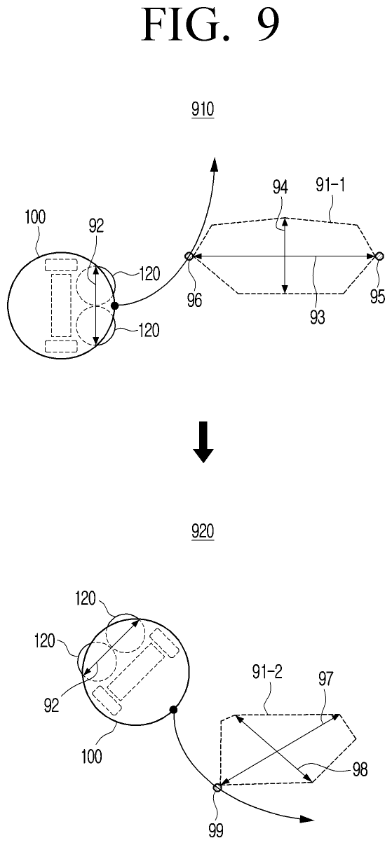

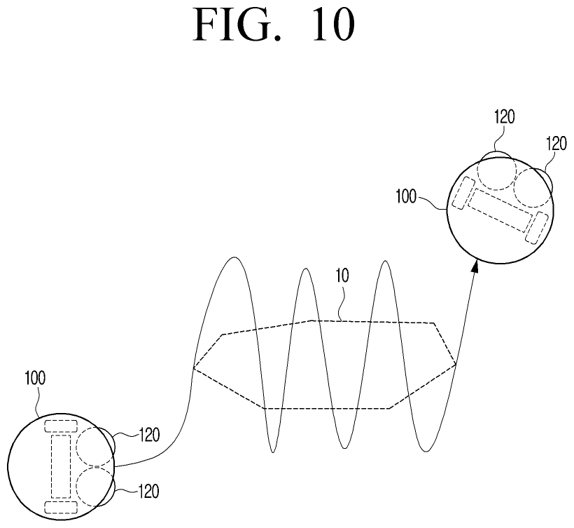

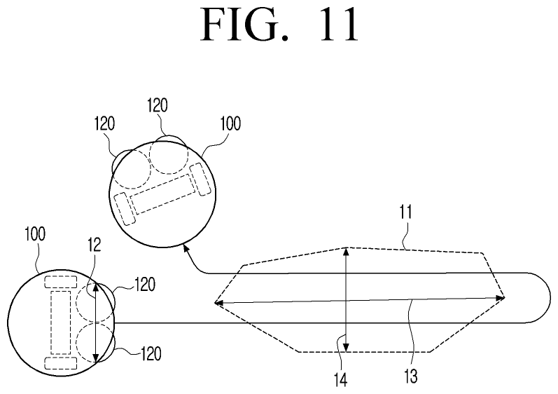

FIG. 7 is a flowchart provided to explain one or more embodiments related to determining a driving path of the robot cleaner 100 based on information about a shape of liquid, and FIGS. 8 to 11 are views provided to explain a driving path of the robot cleaner 100 determined based on information about a shape of liquid.

As described above, the processor 150 may obtain information about liquid present on the floor via the at least one sensor 110 while the robot cleaner 100 is performing a forward drive (S710). Subsequently, based on the information about the shape of the liquid, the processor 150 may identify a horizontal length and a vertical length of the area where the liquid is distributed (S720).

When both the horizontal length and the vertical length are less than a threshold length (S730—Y), the processor 150 may determine a driving path (S740) such that the robot cleaner 100 travels to pass through the center point of the area where the liquid is distributed. Here, the ‘threshold length’ may be determined based on a width of the wet brush 120. For example, the threshold length may be determined to be the same as the width of the wet brush 120 (82 in FIG. 8), and the threshold size may be determined based on various other criteria. Further, the threshold length may be changed according to the settings of the user or developer.

The meaning of determining a driving path so that the robot cleaner 100 travels to pass through the center point of the area where the liquid is distributed has been described above with reference to FIG. 5. For example, when the threshold length is determined to be the same as the width of the wet brush 120, if both the horizontal length and the vertical length are less than the threshold length, it is likely that the wet brush 120 will complete cleaning of the area where the liquid is distributed by passing through the area where the liquid is distributed only once. Accordingly, the processor 150 may determine a driving path such that the robot cleaner 100 travels to pass through the center point (52 in FIG. 5) of the area where the liquid is distributed (51 in FIG. 5), as shown by the arrow in FIG. 5.

When one of the horizontal and the vertical length is less than the threshold length and the other length exceeds the threshold length (S750—N), the processor 150 may determine a driving path so that the robot cleaner 100 travels to pass through a line segment corresponding to the first length that exceeds the threshold length (S760).

As shown in FIG. 8, when a first length 83 among the horizontal length and the vertical length of an area 81 where the liquid is distributed exceeds a threshold length 82, and a second length 84 different from the first length among the horizontal length and the vertical length is less than the threshold length 82, the processor 150 may determine a driving path so that the robot cleaner 100 travels to pass through a line segment corresponding to the first length 8. In FIG. 8, the driving path of the robot cleaner 100 (one-way arrow) and the first length 83 are shown separated from each other to distinguish one from the other. The traveling method in which the wet brush 120 passes through the horizontal length and the vertical length of the area where the liquid is distributed, as shown in FIG. 8, may be simply referred to as ‘linear drive’ or ‘long axis passing drive’.

When both the horizontal length and the vertical length exceed the threshold length (S750—Y), the processor 150 may determine a driving path such that the robot cleaner 100 travels to pass through the one end point that is closest in distance to the robot cleaner 100 among the two end points of the line segment corresponding to the first length exceeding the threshold length (S770).

As shown in 910 of FIG. 9, when both a horizontal length 93 and a vertical length 94 of the area where the liquid is distributed exceed a threshold length 92, the processor 150 may cause the robot cleaner 100 to identify one end point 96 closest to the robot leaner 100 among the two end points 95, 96 of the line segment corresponding to the first length 93 exceeding the threshold length 92 and travel to pass through the identified one end point 96. As described above with reference to FIG. 6, when both the horizontal length and the vertical length exceed the threshold length, if the robot cleaner 100 travels to pass through an end point of the line segment corresponding to the first length exceeding the threshold length, the liquid remains on one side of the area where the robot cleaner has passed, making it possible to perform cleaning efficiently.

When the robot cleaner 100 passes through the identified one end point, it may be necessary to clean up the liquid that remains in the area where the robot cleaner 100 has passed. Accordingly, the processor 150 may again obtain information about the liquid present on the floor via the at least one sensor 110 (S780). The processor 150 may again identify the horizontal length and the vertical length of the area where the liquid remains on the floor based on the information about the shape of the liquid, and may repeat the operations S720 to S770 of determining a driving path for the robot cleaner 100 based on whether the horizontal length and/or the vertical length is less than the threshold length.

For example, after the robot cleaner 100 has traveled to pass through the identified one end point 96 along the driving path in the image 910 of FIG. 9, the processor 150 may obtain information about the liquid remaining on the floor, as shown in an image 920 of FIG. 9, and identify a horizontal length 97 and a vertical length 98 of an area 91-2 where the residual liquid is distributed on the floor based on the information about the shape of the liquid.

In the example of FIG. 9, since both the horizontal length 97 and the vertical length 98 of the area 91-2 where the liquid is distributed exceed the threshold length 92, the processor 150 may determine a driving path such that the robot cleaner 100 travels to pass through an one end point 99 that is closest in distance to the robot cleaner 100 among the two endpoints of the line segment corresponding to the first length 97 exceeding the threshold length 92.

The driving path representing the robot cleaner 100 that has traveled to pass through the identified one end point 99 along the driving path of the image 920 of FIG. 9 and then, completes cleaning of the area 10 where the liquid is distributed by repeating the operations of S720 to S770 may be in the form of a zigzag, as shown in FIG. 10. Of course, when both the horizontal length and the vertical length of the area where the liquid is distributed are less than the threshold length at the time the information about the liquid present on the floor is obtained via the at least one sensor 110, the processor 150 may cause the robot cleaner 100 to pass through the center point of the area where the liquid is distributed to complete cleaning of the area where the liquid is distributed.

In some examples, the processor 150 may determine a driving path in the form of a zigzag in FIG. 11 rather than the zigzag in FIG. 10. For example, as shown in FIG. 11, when both a horizontal length 13 and a vertical length 14 of an area 11 where the liquid is distributed exceed a threshold length 12, but the vertical length 14 is less than twice the threshold length 12, the processor 150 is likely to complete cleaning of the area where the liquid is distributed by passing through the area 11 where the liquid is distributed twice. Therefore, in this case, the processor 150 may determine the driving path in the form of a zigzag as shown by the arrow in FIG. 11.

In addition, the processor 150 may determine a driving path based on a ratio of the horizontal length and the vertical length of the area where the liquid is distributed. For example, based on the fact that the horizontal length 13 is longer among the horizontal length 13 and the vertical length 14 of the area 11 where the liquid is distributed as shown in FIG. 11, the processor 150 may determine a driving path such that the robot cleaner 100 travels drawing a zigzag in a direction parallel to the horizontal length 13.

The driving method in which the wet brush 120 travels the area where the liquid is distributed in the form of a zigzag, as shown in FIGS. 10 and 11, may be simply referred to as ‘zigzag drive.’

While various embodiments of the robot cleaner 100 determining a driving path based on information about liquid have been described above, all of the above embodiments are exemplary and the present disclosure is not limited by the above embodiments.

Once the driving path is determined as described above, information about the determined driving path may be stored in the memory 140, and the information about the driving path stored in the memory 140 may be used to determine a driving path of the robot cleaner 100 after the driving path is stored in the memory 140, or may be used as training data for a neural network model trained to obtain information about liquid or for a neural network model trained to obtain information about a driving path.

Even if the robot cleaner performs cleaning of the liquid while traveling along the driving path determined as described above, it is possible that the cleaning of the liquid is not complete. For example, even if both the horizontal length and the vertical length are identified as being less than the threshold length, and the robot cleaner 100 has traveled to pass through the center point of the area where the liquid is distributed accordingly, the cleaning of the liquid may not be completed depending on the amount of liquid, the nature of the liquid, etc. Furthermore, whether or not the cleaning of the liquid is completed may also depend on what value the threshold length is set to, the water absorption capacity of the wet brush 120, and the like.

Accordingly, the processor 150 may repeat the operations of the embodiments described above after performing the cleaning of the liquid while traveling along the determined driving path as described above. Upon completion of the cleaning of the liquid according to the above-described embodiments, the processor 150 may subsequently perform dry or wet cleaning of areas where the liquid is not distributed.

Although only the process of determining a driving path of the robot cleaner 100 has been described above, as described with reference to FIGS. 1 and 2, the robot cleaner 100 may perform cleaning of liquid while moving in a backward drive where the wet brush 120 faces the direction in which the robot cleaner 100 proceeds. That is, when the driving path of the robot cleaner 100 is determined as described above, the processor 150 may control the driver 130 to cause the robot cleaner 100 to perform a backward drive in accordance with the determined driving path. In other words, the driving path determined according to the embodiments described above, may refer to a backward drive of the robot cleaner 100.

According to one or more embodiments described above with reference to FIGS. 4 to 11, the robot cleaner 100 may determine a path for a backward drive to clean liquid by considering the size, shape, etc. of the liquid, thereby enabling the robot cleaner 100 to clean the liquid on the floor in a more effective and efficient manner.

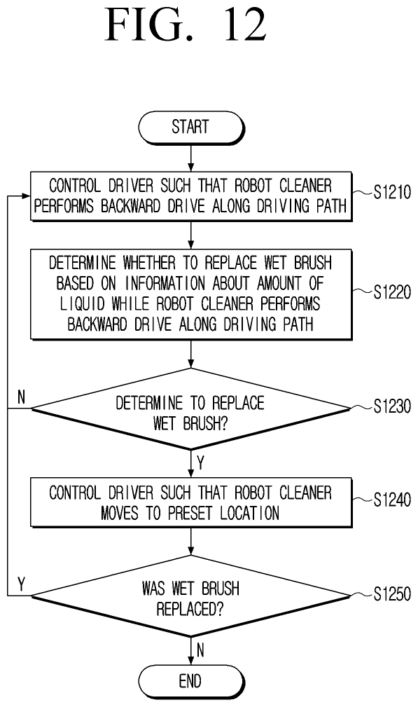

FIG. 12 is a flowchart provided to explain one or more embodiments related to replacing the wet brush 120 while performing a backward drive.

Referring to FIG. 12, the processor 150 may control the driver 130 to cause the robot cleaner 100 to perform a backward drive along a driving path (S1210). Accordingly, the robot cleaner 100 may perform wet cleaning of liquid distributed on the floor while performing a backward drive. While the robot cleaner 100 performs a backward drive along the driving path, the processor 150 may determine whether to replace the wet brush 120 based on information about the amount of liquid (S1220).

Here, ‘replacing the wet brush 120’ may include not only replacing the wet brush 120 itself with a different wet brush 120, but also changing the state of the wet brush 120 by removing moisture from the same wet brush 120 to make it easier to clean the liquid. In addition, replacement of the wet brush 120 may be performed automatically by the robot cleaner 100 and an external device, or may be performed manually by the user.

The processor 150 may obtain information about the amount of liquid based on at least one of a size of the area where the liquid is distributed and a height of the area where the liquid is distributed. For example, the processor 150 may obtain information about the amount of the residual liquid after performing a backward drive along the driving path as illustrated in FIG. 9, and may determine whether to replace the wet brush 120 based on the information about the amount of liquid prior to performing a backward drive along the driving path as illustrated in FIG. 10.

Although FIG. 12 illustrates an exemplary embodiment in which the robot cleaner 100 determines whether to replace the wet brush 120 while performing a backward drive along a driving path, the processor 150 may also determine when to replace the wet brush 120 after obtaining information about the amount of liquid prior to performing a backward drive.

For example, the robot cleaner 100 may include a moisture sensor capable of measuring the amount of moisture contained in the wet brush 120. The processor 150 may determine whether to replace the wet brush 120 based on the amount of moisture obtained via the moisture sensor.

When it is not determined to replace the wet brush 120 (S1230—N), the processor 150 may control the driver 130 to cause the robot cleaner 100 to perform a backward drive along a driving path (S1210). In other words, when it is not determined to replace the wet brush 120, the robot cleaner 100 may proceed with a backward drive along the preset driving path.

When it is determined to replace the wet brush 120 (S1230—Y), the processor 150 may control the driver 130 to move the robot cleaner 100 to a preset location (S1240). Here, the preset location may be the location of an external device (i.e., a charging station) that performs charging of the robot cleaner 100, or it may be a location specified by the user.

When the robot cleaner 100 is moved to the preset location, the wet brush 120 may be replaced by the user. In addition, when it is implemented that the wet brush 120 can be replaced by an external device that performs the charging of the robot cleaner 100, the wet brush 120 may be replaced by the external device.

Once the wet brush 120 is replaced (S1250), the processor 150 may control the driver 130 to cause the robot cleaner 100 to perform a backward drive along a driving path (S1210). In other words, once the replacement of the wet brush 120 is completed, the robot cleaner 100 may proceed with a backward drive along the preset driving path.

As described above, replacing the wet brush 120 may include not only replacing the wet brush 120 itself with a different wet brush 120, but also changing the state of the wet brush 120 by removing moisture from the same wet brush 120 to make it easier to clean the liquid. For example, when the robot cleaner 100 is moved to the preset location, the moisture contained in the wet brush 120 may be removed by the user. In addition, when it is implemented that the moisture of the wet brush 120 can be removed by an external device that performs the charging of the robot cleaner 100, the moisture contained in the wet brush 120 may be removed by the external device.

When it is determined to replace the wet brush 120, the processor 150 may provide a notification to guide the user that the wet brush 120 needs to be replaced (or the moisture of the wet brush 120 needs to be removed). Here, the notification may be provided to the robot cleaner 100, the external device, or the user's user terminal, and the notification may be provided in various ways such as text, voice, or the like.

According to one or more embodiments described above with reference to FIG. 12, the robot cleaner 100 may determine whether to replace the wet brush 120 (or remove the moisture of the wet brush 120) based on the amount of liquid present on the floor, thereby enabling the robot cleaner 100 to clean the liquid on the floor in a more effective and efficient manner.

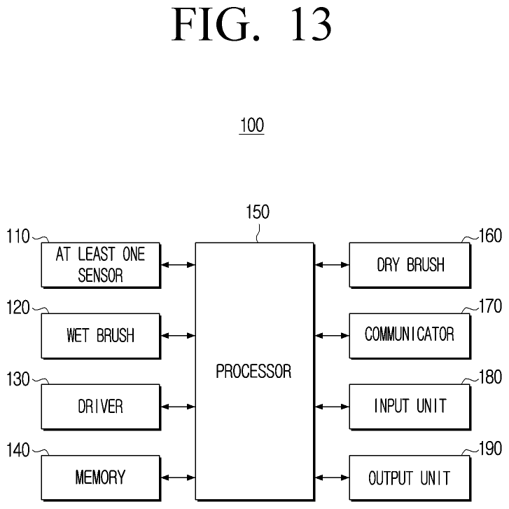

FIG. 13 is a view illustrating configuration of the robot cleaner 100 in detail according to one or more embodiments.

As shown in FIG. 13, the robot cleaner 100 may further include a dry brush 160, a communicator 170, an input unit 180, and an output unit 190 as well as the at least one sensor 110, the wet brush 120, the driver 130, the memory 140, and the processor 150. However, the configurations shown in FIGS. 1 and 13 are exemplary only, and in practicing the present disclosure, new configurations may be added to those shown in FIGS. 1 and 13, or some configurations may be omitted.

The dry brush 160 refers to a brush capable of cleaning the floor while the floor is not wet with water. For example, the dry brush 160 may sweep contaminants, such as dirt, disposed on a floor, such that the suction port of the robot cleaner 100 may easily collect the contaminants. The operation of performing cleaning using the dry brush 160 may be simply referred to as “dry cleaning.’

When the robot cleaner 100 includes both the dry brush 160 and the wet brush 120, and is implemented to control the location of the wet brush 120, the robot cleaner 100 may perform cleaning without using the wet brush 120 when operating in a dry mode, and may perform water cleaning using the wet brush 120 by automatically controlling the location of the wet brush 120 in a wet mode.

The communicator 170 includes circuitry, and may perform communication with an external device. For example, the processor 150 may receive various data or information from an external device connected via the communicator 170, and may transmit various data or information to the external device.

The communicator 170 may include at least one of a Wi-Fi module, a Bluetooth module, a wireless communication module, an NFC module, or a Ultra-Wide Band (UWB) module. Each of the Wi-Fi module and Bluetooth module may perform communication using a Wi-Fi method and a Bluetooth method, respectively. When using a Wi-Fi module or a Bluetooth module, various connection information such as SSID is first transmitted and received, and various information may be transmitted and received after establishing a communication connection using the same.

In addition, the wireless communication module may perform communication according to various communication standards such as IEEE, Zigbee, 3rd Generation (3G), 3rd Generation Partnership Project (3GPP), Long Term Evolution (LTE), 5th Generation (5G), etc. In addition, the NFC module may perform communication in a Near Field Communication (NFC) communication method using a band of 13.56 MHz among various RF-ID frequency bands such as 135 kHz, 13.56 MHz, 433 MHZ, 860˜960 MHz, and 2.45 GHz. In addition, through communication between UWB antennas, the UWB module may accurately measure Time of Arrival (ToA), which is the time for a pulse to reach a target, and Angle of Arrival (AoA), which is the angle of arrival of the pulse at the transmitter, and accordingly, may accurately recognize precise distance and position indoors within an error range of tens of centimeters.

In one or more embodiments, the processor 150 may control the communicator 170 to transmit at least some of the information about liquid, information about a driving route, and information about a decision to replace the wet brush 120 (e.g., a notification to guide the user to replace the wet brush 120 or to remove moisture from the wet brush 120) to an external device (e.g., a user terminal). In addition, the processor 150 may control the communicator 170 to transmit an image of the liquid to a server that provides a neural network model and accordingly, may obtain information about the liquid from the server.

The input unit 180 includes circuitry, and the processor 150 may receive user commands to control the operation of the robot cleaner 100 via the input unit 180. For example, input unit 180 may include configurations such as a microphone, a camera, and a remote control signal receiver. In addition, the input unit 180 may be implemented as a touch screen that is embedded in a display. According to an embodiment, the microphone may receive a voice signal and convert the received voice signal into an electrical signal.

In one or more embodiments, the processor 150 may receive a user input for starting/suspending/ending a cleaning operation via the input unit 180, and may receive various types of user inputs, such as a user input for setting/changing a driving path, a user input for setting a location for replacing the wet brush 120, etc.

The output unit 190 includes circuitry, and the processor 150 may output various functions that can be performed by the robot cleaner 100 via the output unit 190. The output unit 190 may include at least one of a display, a speaker, and an indicator.

The display may output image data under the control of the processor 150. The display may output an image prestored in the memory 140 under control of the processor 150. The display according to one or more embodiments may display a user interface stored in the memory 140. The display may be implemented as a liquid crystal display panel (LCD), organic light emitting diodes (OLED), or the like, and in some cases, the display may also be implemented as a flexible display, a transparent display, or the like. However, the present disclosure is not limited to any particular type of display.

The speaker may output audio data under the control of the processor 150. The indicator may light up under the control of the processor 150. For example, the indicator may light up in various colors under the control of the processor 150. For example, the indicator may be implemented as Light Emitting Diodes (LED), Liquid Crystal Display Panel (LCD), Vacuum Fluorescent Display (VFD), etc., but are not limited thereto.

In one or more embodiments, the processor 150 may output a notification to indicate that the wet brush 120 needs to be replaced or that the moisture of the wet brush 120 needs to be removed via the output unit 190. For example, the processor 150 may control the display to display a message or user interface to indicate that the wet brush 120 needs to be replaced or that the moisture of the wet brush 120 needs to be removed. The processor 150 may also control the speaker to output a voice to guide that the wet brush 120 needs to be replaced or that the moisture of the wet brush 120 needs to be removed. The processor 150 may also output information about liquid, information about a driving path, and the like via the output unit 190.

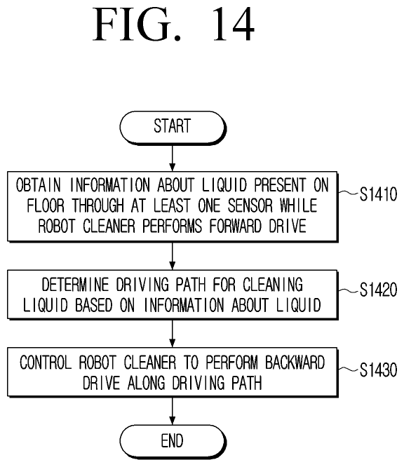

FIG. 14 is a flowchart illustrating a controlling method of the robot cleaner 100 according to one or more embodiments.

As shown in FIG. 14, the robot cleaner 100 may obtain information about liquid present on the floor via the at least one sensor 110 while the robot cleaner 100 is performing a forward drive (S1410).

The robot cleaner 100 may control the robot cleaner 100 to perform a forward drive. The robot cleaner 100 may control the robot cleaner 100 to perform wet cleaning using the wet brush 120 while the robot cleaner 100 is performing a forward drive, and the robot cleaner 100 may control the robot cleaner 100 to perform dry cleaning using the dry brush 160. Further, the robot cleaner 100 may obtain information about liquid while the robot cleaner 100 is performing a forward drive.

Based on the information about the liquid, the robot cleaner 100 may determine a driving path for cleaning the liquid (S1420). The robot cleaner 100 may determine a driving path based on at least one of information about a location of the area where the liquid is distributed on the floor, information about a size of the area where the liquid is distributed on the floor, information about a shape of the area where the liquid is distributed on the floor, and information about an amount of the liquid.

In one or more embodiments, the robot cleaner 100 may determine a driving path such that the robot cleaner 100 passes through at least a portion of the area where the liquid is distributed based on information about the location of the area where the liquid is distributed. In other words, the robot cleaner 100 may determine a driving path such that the robot cleaner 100 passes through the area where the liquid is distributed, rather than avoiding the area where the liquid is distributed.

In one or more embodiments, the robot cleaner 100 may identify, based on information about the size of the area where the liquid is distributed, whether the size of the area where the liquid is distributed is less than a threshold size. As a result of the identification, when the size of the area where the liquid is distributed is less than the threshold size, the robot cleaner 100 may determine a driving path such that the robot cleaner 100 travels to pass through the center point of the area where the liquid is distributed. Conversely, when the size of the area where the liquid is distributed exceeds the threshold size, the robot cleaner 100 may determine a driving path based on information about the shape where the liquid is distributed.

In one or more embodiments, the robot cleaner 100 may identify a horizontal length and a vertical length of the area where the liquid is distributed based on information about the shape of the area where the liquid is distributed. Subsequently, the robot cleaner 100 may identify whether the horizontal length and the vertical length of the area where the liquid is distributed are less than a preset threshold length. As a result of the identification, when the horizontal length and the vertical length are less than the threshold length, the robot cleaner 100 may determine a driving path such that the robot cleaner 100 travels to pass through the center point of the area where the liquid is distributed. Conversely, when at least one of the horizontal length and the vertical length is greater than the threshold length, the robot cleaner 100 may determine a driving path based on the shape where the liquid is distributed.

The robot cleaner 100 may control the robot cleaner 100 to perform a backward drive along a driving path of the robot cleaner 100 (S1430). As described above, the backward drive refers to driving with the rear of the robot cleaner 100 facing a destination, such that while performing a backward drive, the wet brush 120 disposed at the rear of the robot cleaner 100 faces the direction in which the robot cleaner 100 proceeds. In this case, in order to reduce the likelihood of contamination, degradation, or failure of a plurality of wheels, the dry brush 160, etc. by the liquid, the robot cleaner 100 may control the robot cleaner 100 to perform a backward drive when the robot cleaner 100 passes through at least a portion of the area where the liquid is distributed.

In order to perform a backward drive, the robot cleaner 100 may control the driver 130 such that the wet brush 120 faces the direction in which the robot cleaner 100 proceeds and accordingly, the robot cleaner 100 may be rotated such that the wet brush 120 faces the direction in which the robot cleaner 100 proceeds. Once the robot cleaner 100 is rotated such that the wet brush 120 faces the direction in which the robot cleaner 100 proceeds, the robot cleaner 100 may control the driver 130 such that the robot cleaner 100 performs a backward drive along a driving path determined based on information about the liquid.

The wet brush 120 may face a direction opposite to the direction in which the robot cleaner 100 proceeds while a forward drive of the robot cleaner 100 is performed, and face the direction in which the robot cleaner 100 proceeds while a backward drive of the robot cleaner 100 is performed.

The controlling method of the robot cleaner 100 according to the above-described embodiments may be implemented as a program and provided to the robot cleaner 100. The program including the controlling method of the robot cleaner 100 may be stored in a non-transitory computer readable medium and provided to the robot cleaner 100.

For example, in a non-transitory computer-readable recording medium including a program that executes a controlling method of the robot cleaner 100 including the wet brush 120, the controlling method of the robot cleaner 100 may include: obtaining, the via at least one sensor 110, information about liquid present on the floor while the robot cleaner 100 is performing a forward drive, based on the information about the liquid, determining a driving path for cleaning the liquid, and controlling the robot cleaner 100 to perform a backward drive along the driving path, and the wet brush 120 may face a direction opposite to the direction in which the robot cleaner 100 proceeds while the forward drive is performed, and the wet brush 120 may face the direction in which the robot cleaner 100 proceeds while the backward drive is performed.

While the controlling method of the robot cleaner 100 and the computer-readable recording medium including a program that executes the controlling method of the robot cleaner 100 have been briefly described above, this is only to avoid redundant description, and various embodiments of the robot cleaner 100 may also be applied with respect to the controlling method of the robot cleaner 100 and the computer-readable recording medium including a program that executes the controlling method of the robot cleaner 100.

The functions related to artificial intelligence according to the present disclosure may be operated by the processor 150 and the memory 140 of the robot cleaner 100.

The processor 150 may include of one or a plurality of processors 150. The one or more processors 150 may include at least one of a central processing unit (CPU), a graphics processing unit (GPU), or a neural processing unit (NPU), but are not limited to examples of the above-described processors 150.

The CPU is a generic-purpose processor 150 which may perform not only general calculations but also artificial intelligence calculations, and may efficiently execute complex programs through a multi-layered cache structure. The CPU may be advantageous for a serial processing method that enables organic linkage between the previous calculation result and the next calculation result through sequential calculation. The generic-purpose processor is not limited to the above examples except for a case where the processor 150 is specified as the above-mentioned CPU.

The GPU is a processor 150 for large-scale operations such as floating-point operations used for graphics processing, and may perform the large-scale operations in parallel by integrating a large number of cores. The GPU may be advantageous for a parallel processing method such as a convolution operation or the like, compared to the CPU. In addition, the GPU may be used as a co-processor 150 to supplement the function of the CPU. The processor 150 for the large-scale operations is not limited to the above example except for a case where the processor 150 is specified as the above-mentioned GPU.

The NPU is a processor 150 specialized in artificial intelligence calculation using an artificial neural network, and each layer constituting the artificial neural network may be implemented as hardware (e.g., silicon). Here, the NPU is specially designed based on requirements of a company, and may thus have a lower degree of freedom than the CPU or the GPU, but the NPU may efficiently process the artificial intelligence calculation required by the company. As the processor 150 specialized for the artificial intelligence calculation, the NPU may be implemented in various forms such as a tensor processing unit (TPU), an intelligence processing unit (IPU), or a vision processing unit (VPU). The artificial intelligence processor 150 is not limited to the above example except for a case where the processor is specified as the above-mentioned NPU

In addition, one or more processors 150 may be implemented as a system on chip (SoC). Here, the SoC may further include the memory 140 and a network interface such as a bus for data communication between the processor 150 and the memory 140 in addition to the one or more processors 150.

In case that the system on chip (SoC) included in the robot cleaner 100 includes a plurality of processors 150, the robot cleaner 100 may use some of the plurality of processors 150 to perform the artificial intelligence calculation (e.g., calculation related to the learning or inference of an artificial intelligence model). For example, the robot cleaner 100 may perform the artificial intelligence calculation by using at least one of the GPU, NPU, VPU, TPU, or a hardware accelerator that is specialized for the artificial intelligence calculation such as convolution calculation and matrix multiplication calculation among the plurality of processors 150. However, this is only an example, and the artificial intelligence calculation may be processed using a generic-purpose processor 150 such as the CPU.

In addition, the robot cleaner 100 may perform calculation for a function related to the artificial intelligence by using multi-cores (e.g., dual-core or quad-core) included in one processor 150. The robot cleaner 100 may perform the artificial intelligence calculation such as the convolution calculation and the matrix multiplication calculation in parallel using the multi-cores included in the processor 150.

The one or more processors 150 may control to process the input data based on a predefined operation rule or artificial intelligence model stored in the memory 140. The predefined operation rule or artificial intelligence model may be acquired by the learning.

Here, “acquired by the learning” may indicate that the predefined operation rule or artificial intelligence model of a desired feature is acquired by applying a learning algorithm to a lot of learning data. Such learning may be performed on a device itself where the artificial intelligence is performed according to an embodiment, or by a separate server/system.

The artificial intelligence model may include a plurality of neural network layers. At least one layer has at least one weight value, and calculation of the layer may be performed through an operation result of a previous layer and at least one defined operation. Examples of the neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, and a transformer, and the neural network in this disclosure is not limited to the above examples except for a case where a type of the neural network is specified.

The learning algorithm is a method of training a predetermined target device (e.g., robot) by using a large number of learning data for the predetermined target device to make a decision or a prediction by itself. The learning algorithms may include, for example, a supervised learning algorithm, an unsupervised learning algorithm, a semi-supervised learning algorithm, or a reinforcement learning algorithm, and the learning algorithm of this disclosure is not limited to the above-described examples, unless specified otherwise.

The machine-readable storage medium may be provided in the form of a non-transitory storage medium. Here, the ‘non-temporary storage medium’ only means that it is a tangible device and does not include signals (e.g., electromagnetic waves), and this term does not distinguish between a case in which data is stored semi-permanently in a storage medium and a case in which data is stored temporarily. For example, the ‘non-temporary storage medium’ may include a buffer in which data is temporarily stored.

According to one or more embodiments, the methods according to the various embodiments disclosed in this document may be included and provided in a computer program product. The computer program product may be traded as a product between a seller and a purchaser. The computer program product may be traded as a product between a seller and a purchaser. The computer program product can be distributed in the form of a storage medium that is readable by machines (e.g.: a compact disc read only memory (CD-ROM)), or distributed directly on-line (e.g.: download or upload) through an application store (e.g.: PlayStore™), or between two user devices (e.g.: smartphones). In the case of on-line distribution, at least a portion of a computer program product (e.g.: a downloadable app) may be stored in a storage medium readable by machines such as the server of the manufacturer, the server of the application store, or the memory 140 of the relay server at least temporarily, or may be generated temporarily.

As described above, each of the components (e.g., modules or programs) according to the various embodiments may include a single entity or a plurality of entities, and some of the corresponding sub-components described above may be omitted or other sub-components may be further included in the various embodiments. Alternatively or additionally, some of the components (e.g., the modules or the programs) may be integrated into one entity, and may perform functions performed by the respective corresponding components before being integrated in the same or similar manner.

Operations performed by the modules, the programs or other components according to the various embodiments may be executed in a sequential manner, a parallel manner, an iterative manner or a heuristic manner, and at least some of the operations may be performed in a different order or be omitted, or other operations may be added.

Meanwhile, terms “˜er/or” or “module” used in the disclosure may include units configured by hardware, software, or firmware, and may be used compatibly with terms such as, for example, logics, logic blocks, parts, circuits, or the like. The “˜er/or” or “module” may be an integrally configured part or a minimum unit performing one or more functions or a part thereof. For example, the module may be configured by an application-specific integrated circuit (ASIC).

Various embodiments according to the present may be implemented in software including an instruction stored in a machine-readable storage medium (e.g., computer). A machine may be a device that invokes the stored instruction from the storage medium and is operated based on the invoked instruction, and may include an electronic apparatus (e.g., robot cleaner 100) according to embodiments disclosed herein.

In case that the instruction is executed by the processor, the processor may directly perform a function corresponding to the instruction or other components may perform the function corresponding to the instruction under control of the processor. The instruction may include codes provided or executed by a compiler or an interpreter.

Hereinabove, the exemplary embodiments of the disclosure have been described but the disclosure is not limited to the specific embodiment and may be variously modified by a person skilled in the art to which the disclosure pertains without departing from the gist of the disclosure as described herein, and such modifications should not be individually understood from technical concepts or prospects of the disclosure.

What is claimed is:

1. A robot cleaner comprising:
at least one sensor;
a wet brush;
a driver;
at least one memory storing at least one instruction; and
at least one processor configured to execute the at least one instruction,
wherein, by executing the at least one instruction, the at least one processor is configured to:
obtain information about liquid on a floor through the at least one sensor in a state in which the robot cleaner performs a forward drive;
determine a driving path for cleaning the liquid based on the information about the liquid; and
control the driver to cause the robot cleaner to perform a backward drive along the driving path, and
wherein the wet brush faces a direction opposite to a direction in which the robot cleaner proceeds in the state in which the forward drive is performed, and faces a direction in which the robot cleaner proceeds in a state in which the backward drive is performed.

2. The robot cleaner as claimed in claim 1, wherein the at least one processor is further configured to:
store information about the driving path in the at least one memory; and
control the driver to perform the backward drive based on the information about the driving path stored in the at least one memory.

3. The robot cleaner as claimed in claim 1, wherein the information about the liquid comprises at least one of information about a location of an area of the liquid, information about a size of the area of the liquid, information about a shape of the area of the liquid, or information about an amount of the liquid.

4. The robot cleaner as claimed in claim 3, wherein the at least one processor is further configured to determine the driving path to pass through at least a portion of the area of the liquid based on the information about the location of the area of the liquid.

5. The robot cleaner as claimed in claim 4, wherein the at least one processor is further configured to:
identify a size of the area based on the information about the size of the area of the liquid;
based on the size of the area being less than a threshold size, determine the driving path to pass through a center point of the area; and
based on the size of the area exceeding the threshold size, identify a polygon corresponding to the area based on the information about the shape of the area of the liquid, and determine the driving path to pass through a vertex that is closest to the robot cleaner among a plurality of vertices included in the polygon.

6. The robot cleaner as claimed in claim 5, wherein the at least one processor is further configured to:
detect an outline of the area based on the information about the shape of the area of the liquid; and
identify the polygon corresponding to the area by performing simplification on the detected outline.

7. The robot cleaner as claimed in claim 6, wherein the at least one processor is further configured to:
identify a horizontal length of the area and a vertical length of the area based on the information about the shape of the area of the liquid; and
based on the horizontal length and the vertical length being less than a preset threshold length, determine the driving to pass through the center point of the area.

8. The robot cleaner as claimed in claim 7, wherein the at least one processor is further configured to, based on a first length among the horizontal length and the vertical length exceeding the preset threshold length and a second length among the horizontal length and the vertical length being less than the preset threshold length, determine the driving path to pass through a line segment corresponding to the first length.

9. The robot cleaner as claimed in claim 8, wherein the at least one processor is further configured to:
based on the horizontal length and the vertical length exceeding the preset threshold length, determine the driving path to pass through an end point that is closest to the robot cleaner among two end points of the line segment corresponding to the first length; and
based on the robot cleaner passing through the end point, obtain second information about the liquid through the at least one sensor.

10. The robot cleaner as claimed in claim 9, wherein the at least one processor is further configured to:
determine whether to replace the wet brush based on the information about the amount of the liquid in the state in which the robot cleaner performs the backward drive along the driving path;
based on determining that the wet brush is to be replaced, control the driver to cause the robot cleaner to move to a preset location; and
based on the wet brush being replaced, control the driver to cause the robot cleaner to perform the backward drive along the driving path.

11. The robot cleaner as claimed in claim 1, further comprising:
a communicator,
wherein the at least one processor is further configured to control the communicator to transmit to an external device at least some of the information about the liquid, information about the driving path, and information indicating whether the wet brush is to be replaced.

12. A controlling method of a robot cleaner including a wet brush, the method comprising:
obtaining information about liquid on a floor through at least one sensor in a state in which the robot cleaner performs a forward drive;
determining a driving path for cleaning the liquid based on the information about the liquid; and
controlling the robot cleaner to perform a backward drive along the driving path,
wherein the wet brush faces a direction opposite to a direction in which the robot cleaner proceeds in the state in which the forward drive is performed, and faces a direction in which the robot cleaner proceeds in a state in which the backward drive is performed.

13. The method as claimed in claim 12, further comprising:
storing information about the driving path,
wherein the controlling the robot cleaner comprises controlling the robot cleaner to perform the backward drive based on the stored information about the driving path.

14. The method as claimed in claim 12, wherein the information about the liquid includes at least one of information about a location of an area of the liquid, information about a size the area of the liquid, information about a shape of the area of the liquid, and information about an amount of the liquid.

15. The method as claimed in claim 14, wherein the determining the driving path comprises determining the driving path to pass through at least a portion of the area of the liquid based on the information about the location of the area of the liquid.

16. A robot cleaner comprising:
at least one sensor on a first side of the robot cleaner corresponding to a front direction;
a wet brush on a second side of the robot cleaner corresponding to a backward direction;
a driver;
at least one memory storing at least one instruction; and
at least one processor configured to execute the at least one instruction,
wherein, by executing the at least one instruction, the at least one processor is configured to:
obtain information about liquid on a floor through the at least one sensor;
determine a driving path for cleaning the liquid based on the information about the liquid; and
control the driver to cause the robot cleaner to perform a backward drive along the driving path, and
wherein the wet brush faces the backward direction in a state in which the backward drive is performed.

17. The robot cleaner as claimed in claim 16, wherein the information about the liquid comprises information about a location of an area of the liquid, and
wherein the at least one processor is further configured to determine the driving path to pass through at least a portion of the area of the liquid based on the information about the location of the area of the liquid.

18. The robot cleaner as claimed in claim 16, wherein the information about the liquid comprises information about a size of an area of the liquid, and wherein the at least one processor is further configured to:
based on the size of the area being less than a threshold size, determine the driving path to pass through a center point of the area; and
based on the size of the area exceeding the threshold size, identify a polygon corresponding to the area based on a shape of the area of the liquid, and
determine the driving path to pass through a vertex that is closest to the robot cleaner among a plurality of vertices included in the polygon.

19. The robot cleaner as claimed in claim 18, wherein the at least one processor is further configured to:
identify a horizontal length of the area and a vertical length of the area based on the shape of the area of the liquid; and
based on the horizontal length and the vertical length being less than a preset threshold length, determine the driving to pass through the center point of the area.

20. The robot cleaner as claimed in claim 19, wherein the at least one processor is further configured to:
based on a first length among the horizontal length and the vertical length exceeding the preset threshold length and a second length among the horizontal length and the vertical length being less than the preset threshold length, determine the driving path to pass through a line segment corresponding to the first length;
based on the horizontal length and the vertical length exceeding the preset threshold length, determine the driving path to pass through an end point that is closest to the robot cleaner among two end points of the line segment corresponding to the first length;
based on the robot cleaner passing through the end point, obtain second information about the liquid through the at least one sensor; and
determine a second driving path for cleaning the liquid based on the second information about the liquid.
